(19) United States
(12) Patent Application Publication
(10) Pub. No.: US 2008/0261134 A1
(43) Pub. Date: Oct. 23, 2008

(54) DEVELOPING APPARATUS, DEVELOPING METHOD AND IMAGE FORMING APPARATUS

(75) Inventor: Mitsutoshi Watanabe, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/104,487

(22) Filed: Apr. 17, 2008

Related U.S. Application Data
(60) Provisional application No. 60/912,199, filed on Apr. 17, 2007.

(51) Int. Cl. G03G 13/04

(52) U.S. Cl. 430/48

(57) ABSTRACT

A developing apparatus, a developing method and an image forming apparatus are provided in which reduction in the quantity of development is prevented in the case where a micro particle diameter toner is used. The developing apparatus uses a developer containing a toner and supplies the toner to an image carrier. The developing apparatus includes: a developer housing unit configured to house the developer; a developer carrier in which at least one of magnets provided therein is formed by an electromagnet, and which carries the developer from the developer housing unit toward the image carrier; a developer carrying regulating unit configured to regulate the developer carried by the developer carrier; and an electromagnet driving unit configured to vary a voltage to be applied to the electromagnet.

### BACKGROUND OF THE INVENTION

1. Field of the Invention

The present invention relates to a developing apparatus, a developing method and an image forming apparatus that use a toner with a small particle diameter.

2. Description of the Related Art

Recently, in the image forming method using an electrophotographic system, the particle diameter of the toner has increasingly been reduced in order to achieve high image quality equivalent to that of offset printing. Here, a developing apparatus in a conventional image forming apparatus will be described. FIG. 5 is a sectional view showing an example of a conventional developing apparatus. A developing apparatus 1 has a stirring roller 2, a carrying roller 4, a development sleeve 5, magnet members 6a, 6b, 6c, 6d and 6e, and a carrying regulating unit 7.

A two-component developer (including a toner and a carrier) in the developing apparatus 1 is supplied to the development sleeve 5 (developer carrier) while it is stirred by a developer carrying unit including the stirring roller 2 and the carrying roller 4. The development sleeve 5 is a cylindrical unit made of a non-magnetic member. The magnet members 6a, 6b, 6c, 6d and 6e are provided in the development sleeve 5. The magnetic poles of the magnet members 6d, 6e, 6a, 6b and 6c, which are permanent magnets, are N-pole, S-pole, N-pole, S-pole and N-pole.

The developer supplied to this development sleeve 5 is carried as the development sleeve 5 rotates. The quantity of the developer carried is regulated by the carrying regulating unit 7. The developer is thus carried to a position facing a developing position on a photoconductive body 8 (photoconductive drum, image carrier). At a part of the surface of the development sleeve 5 that faces an electrostatic latent image on the surface of the photoconductive body 8, the toner shifts away from the carrier and moves toward the electrostatic latent image on the surface of the photoconductive body 8 because of the potential difference between the voltage applied to the development sleeve 5 and the potential on the surface of the photoconductive body 8. The carrier returns into the developing apparatus 1 while remaining on the surface of the development sleeve 5.

Here, in the case where the toner in the developer has a volume average particle diameter of 5 μm or less (hereinafter referred to as a micro diameter toner), the reduction in the particle diameter of the toner causes reduction in the surface area of each particle and hence reduction in the charging quantity per toner particle if the charging quantity density per area is equivalent. Of the adhesive forces that act between the carrier and the toner, the ratio of the adhesive forces except for the mirror image force due to charges on the toner surface, represented by the van der Waals force, increases, and the toner charging quantity per unit mass increases. Therefore, the movement of the toner toward the electrostatic latent image cannot easily occur. Consequently, reduction in the quantity of the toner adhering to the photoconductive body and reduction in the image density occur. Even if the potential difference between the development sleeve 5 and the photoconductive body 8 is increased for development, the toner and the carrier are hard to separate from each other.

Conventionally, there is a technique of superimposing an AC voltage on a developing bias and oscillating the developer on the development sleeve 5, thereby increasing the quantity of the toner adhering to the drum. However, for a micro diameter toner with a diameter of 5 μm or less, the reduction in the adhesive force between the carrier and the toner and the reduction in the charging quantity of toner particles cause poor electric field mobility and the toner cannot easily move toward the electrostatic latent image.

To solve this problem, for example, JP-A-2000-81722 and JP-A-2000-98657 disclose techniques for realizing an optimum development property by utilizing the resistance and particle diameter of a carrier in a developing system using a toner with a volume average particle diameter of 5 μm or less. However, the adhesive force that acts between the carrier and the toner increases as the particle diameter is decreased. Thus, the quantity of development is reduced.

Also, for example, JP-A-2006-79019 and JP-A-2005-352248 disclose systems for developing a toner with a particle diameter of 5 μm or less by applying oscillation energy to a developing nip part. However, since oscillation is applied to the photoconductive body, the oscillation influences development, transfer and so on, and there is a problem that a jitter occurs in the output image.

### SUMMARY OF THE INVENTION

According to an embodiment of the invention, a developing apparatus, a developing method and an image forming apparatus are provided that prevent reduction in the quantity of development in the case where a micro particle diameter toner is used.

To solve the above problems, a developing apparatus according to an aspect of the invention uses a developer containing a toner and supplies the toner to an image carrier. The developing apparatus includes: a developer housing unit configured to house the developer; a developer carrier in which at least one of magnets provided therein is formed by an electromagnet, and which carries the developer from the developer housing unit toward the image carrier; a developer carrying regulating unit configured to regulate the developer carried by the developer carrier; and an electromagnet driving unit configured to vary a voltage to be applied to the electromagnet.

A developing method according to another aspect of the invention is adapted for using a developer containing a toner and supplying the toner from a developer carrier to an image carrier. The developing method includes: varying a voltage to be applied to an electromagnet to attract the developer to the developer carrier, and providing a potential difference between the developer carrier and the image carrier; and carrying the developer by the developer carrier toward the image carrier.

An image forming apparatus according to still another aspect of the invention forms a toner image by using a developer containing a toner. The image forming apparatus includes: an image carrier on which the toner image is formed with the toner; a developer housing unit configured to house the developer; a developer carrier in which at least one of magnets provided therein is formed by an electromagnet, and which carries the developer from the developer housing unit toward the image carrier; a developer carrying regulating unit configured to regulate the developer carried by the developer carrier; an electromagnet driving unit configured to vary a voltage to be applied to the electromagnet; and a charging unit configured to provide a potential difference between the developer carrier and the image carrier.

### DESCRIPTION OF THE DRAWINGS

FIG. 1 is a configuration view showing an exemplary configuration of an image forming apparatus according to an embodiment.

FIG. 2 is a sectional view showing an exemplary configuration of a developing apparatus according to the embodiment.

FIG. 3 is a view showing an exemplary layout of an electromagnet according to the embodiment.

FIG. 4 shows a waveform that indicates an exemplary change with time in electromagnet driving voltage by an electromagnet driving unit according to the embodiment.

FIG. 5 is a sectional view showing an example of a conventional developing apparatus.

### DESCRIPTION OF THE EMBODIMENTS

Hereinafter, an embodiment of the invention will be described with reference to the drawings.

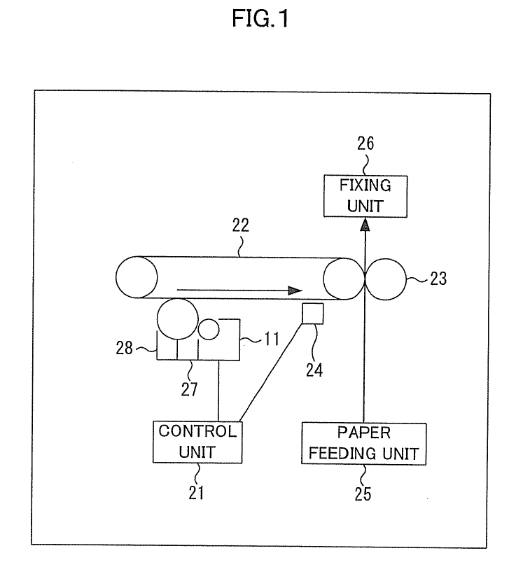

FIG. 1 is a configuration view showing an exemplary configuration of an image forming apparatus according to the embodiment. This image forming apparatus has a photoconductive body 8, a developing apparatus 11, a control unit 21, a transfer belt 22, a transfer roller 23, an image quality maintenance sensor 24, a paper feeding unit 25, a fixing unit 26, a charging unit 27, and an exposure unit 28.

The control unit 21 controls each unit. The charging unit 27 charges the photoconductive body 8. The exposure unit 28 forms an electrostatic latent image on the photoconductive body 8. As a toner is supplied from the developing apparatus 11 to the photoconductive body 8, a toner image is formed that is based on the electrostatic latent image on the photoconductive body 8. Next, the toner image on the photoconductive body 8 is transferred to the transfer belt 22. Meanwhile, as the paper feeding unit 25 supplies a sheet, the sheet is carried to the transfer roller 23. The transfer roller 23 transfers the toner image on the transfer belt 22 to the sheet. The fixing unit 26 fixes the toner image on the sheet.

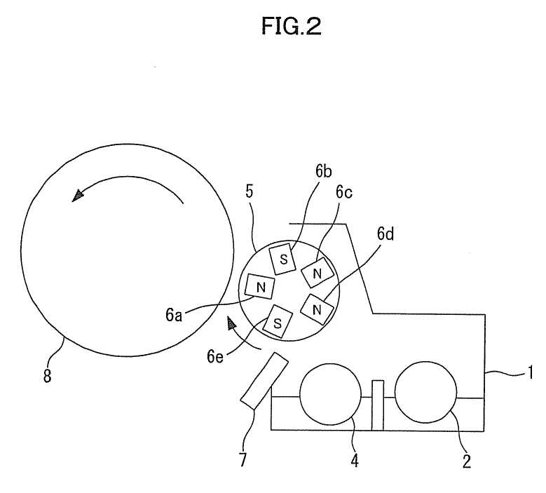

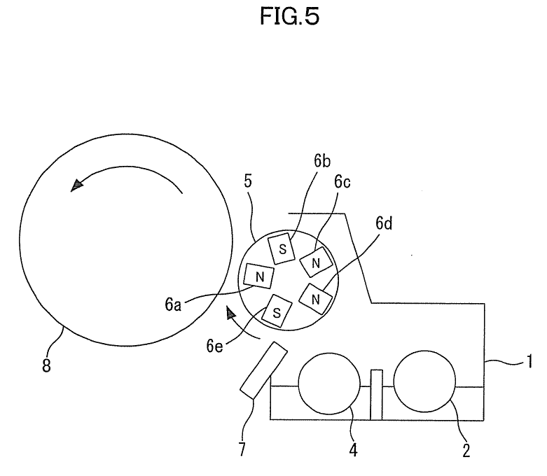

FIG. 2 is a sectional view showing an exemplary configuration of the developing apparatus according to the embodiment. In FIG. 2, the same reference numerals as in FIG. 5 denote the same or equivalent parts as in FIG. 5, and therefore these parts will not be described further in detail. Compared to FIG. 5, the developing apparatus 11 is provided instead of the developing apparatus 1. The developing apparatus 11 has an electromagnet 16 instead of the magnet member 6a, and additionally has an electromagnet driving unit 19.

A toner as a component of a two-component developer in the developing apparatus 11 has a volume average particle diameter of 2 to 5 μm. The toner is supplied to the development sleeve 5 while being stirred together with a carrier by the developer carrying unit including the stirring roller 2 and the carrying roller 4. The development sleeve 5 is a cylindrical unit made of a non-magnetic member.

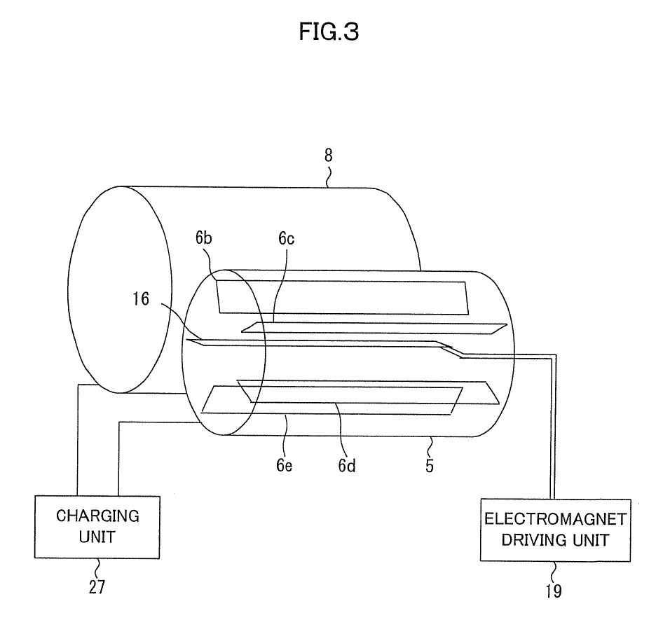

FIG. 3 is a view showing an exemplary layout of an electromagnet according to the embodiment. As a magnet member (main pole) at a position in the development sleeve 5 that faces the photoconductive body 8, the electromagnet 16 is provided instead of the magnet member 6a. The other magnet members 6d, 6e, 6b and 6c are permanent magnets. The charging unit 27 changes the development sleeve 5 and the photoconductive body 8. Electromagnets may be used instead of the permanent magnets.

When the developing apparatus 11 is operating, the charging unit 27 provides a potential difference between the development sleeve 5 and the photoconductive body 8, and the electromagnet driving unit 19 provides a voltage to the electromagnet 16.

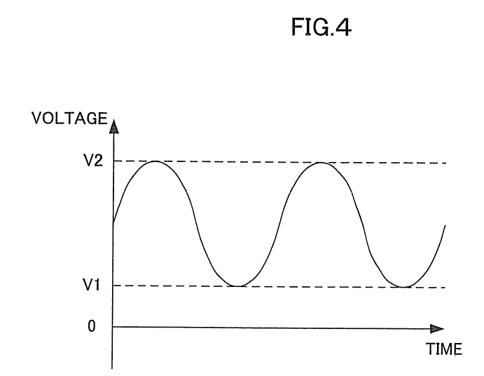

The electromagnet driving unit 19 applies a voltage that is acquired by superimposing an AC component on a DC component, to the electromagnet 16. FIG. 4 shows a waveform indicating an exemplary change with time in the electromagnet driving voltage by the electromagnet driving unit according to the embodiment. As shown in FIG. 4, the waveform of the electromagnet driving voltage is a sine wave. While other waveforms such as a rectangular wave may also be used, a waveform that allows the developer to move continuously, such as a sine wave, is desirable. The AC component of the electromagnet driving voltage is set at the frequency of 5 to 20 kHz.

If the magnetic force of the electromagnet 16 is too weak, the quantity of the developer carried is small. Therefore, the minimum value V1 of the electromagnet driving voltage is set to be larger than 0 and at least at a level that enables the magnet members 6b, 6c, 6d and 6e and the electromagnet 16 to carry the developer. Thus, the polarity (N-pole) of the electromagnet 16 is maintained.

Meanwhile, if the magnetic force of the electromagnet 16 is too strong, the developer may become clogged between the development sleeve 5 and the carrying regulating unit 7, or the developer may become clogged between the development sleeve 5 and the photoconductive body 8. Therefore, the maximum value V2 of the electromagnet driving voltage is set at such a level that the clogging of the developer does not occur.

The variance in the magnetic force of the electromagnet 16 can vary chain formation of the developer carried on the surface of the development sleeve 5. As the strength of the magnetic force of the electromagnet 16 intermittently changes, the toner and carrier become more easily separable. Consequently, a toner cloud (the toner separated from the carrier and forming a mist in the air) tends to be generated. Thus, the toner can be easily released from the carrier and provided onto the photoconductive body 8 for development, without excessively raising the development contrast. The toner, which has formed the toner cloud after being released from the carrier and has negative charges, moves onto the photoconductive body 8.

The electromagnet driving unit 19 may also be controlled by using the image quality maintenance sensor 24.

For example, since the charging quantity diminishes toward the end of the developer's life, the control unit 21 can decrease or stop the amplitude of the voltage of the electromagnet driving unit 19 in accordance with the image density detected by the image quality maintenance sensor 24. The control unit 21 can also control the voltage of the electromagnet driving unit 19 in accordance with the image density detected by the image quality maintenance sensor 24, in order to deal with environmental changes (temperature and humidity changes). Alternatively, the control unit 21 can control both the charging unit 27 and the electromagnet driving unit 19 in accordance with the image density detected by the image quality maintenance sensor 24.

According to this embodiment, when development is carried out with a toner having a volume average particle diameter of 5 μm or less, the magnetic force of the electromagnet 16 can be changed to vary the binding force of the developer and to easily separate the toner and carrier.

The specific embodiment of the invention has been described above in detail. However, it is obvious to those skilled in the art that various changes and modifications can be made without departing from the scope and spirit of the invention.

What is claimed is:

1. A developing apparatus that uses a developer containing a toner and supplies the toner to an image carrier, the developing apparatus comprising:
a developer housing unit configured to house the developer;
a developer carrier in which at least one of magnets provided therein is formed by an electromagnet, and which carries the developer from the developer housing unit toward the image carrier;
a developer carrying regulating unit configured to regulate the developer carried by the developer carrier; and
an electromagnet driving unit configured to vary a voltage to be applied to the electromagnet.

2. The developing apparatus according to claim 1, wherein the electromagnet is provided at a position facing the image carrier, within the developer carrier.

3. The developing apparatus according to claim 1, wherein the voltage to be applied to the electromagnet by the electromagnet driving unit has a DC component and an AC component.

4. The developing apparatus according to claim 1, wherein the voltage to be applied to the electromagnet by the electromagnet driving unit has its polarity unchanged.

5. The developing apparatus according to claim 1, wherein the toner has a volume average particle diameter of 5 μm or less.

6. The developing apparatus according to claim 1, wherein the developer carrier carries the developer, and
a magnet having polarity opposite to the polarity of the electromagnet is further provided before and after the electromagnet in the carrying direction.

7. A developing method adapted for using a developer containing a toner and supplying the toner from a developer carrier to an image carrier, the developing method comprising:
varying a voltage to be applied to an electromagnet to attract the developer to the developer carrier, and providing a potential difference between the developer carrier and the image carrier; and
carrying the developer by the developer carrier toward the image carrier.

8. The developing method according to claim 7, wherein the electromagnet is provided within the developer carrier.

9. The developing method according to claim 8, wherein the electromagnet is provided at a position facing the image carrier, within the developer carrier.

10. The developing method according to claim 7, wherein the voltage to be applied to the electromagnet by the electromagnet driving unit has a DC component and an AC component.

11. The developing method according to claim 7, wherein the voltage to be applied to the electromagnet by the electromagnet driving unit has its polarity unchanged.

12. The developing method according to claim 7, wherein the toner has a volume average particle diameter of 5 μm or less.

13. The developing method according to claim 7, wherein the developer carrier carries the developer, and
a magnet having polarity opposite to the polarity of the electromagnet is further provided within the developer carrier and before and after the electromagnet in the carrying direction of the developer.

14. An image forming apparatus that forms a toner image by using a developer containing a toner, the image forming apparatus comprising:
an image carrier on which the toner image is formed with the toner;
a developer housing unit configured to house the developer;
a developer carrier in which at least one of magnets provided therein is formed by an electromagnet, and which carries the developer from the developer housing unit toward the image carrier;
a developer carrying regulating unit configured to regulate the developer carried by the developer carrier;
an electromagnet driving unit configured to vary a voltage to be applied to the electromagnet; and
a charging unit configured to provide a potential difference between the developer carrier and the image carrier.

15. The image forming apparatus according to claim 14, wherein the electromagnet is provided at a position facing the image carrier, within the developer carrier.

16. The image forming apparatus according to claim 14, wherein the voltage to be applied to the electromagnet by the electromagnet driving unit has a DC component and an AC component.

17. The image forming apparatus according to claim 14, further comprising a sensor that detects image density, wherein the electromagnet driving unit controls the voltage to be applied to the electromagnet in accordance with the image density detected by the sensor.

18. The image forming apparatus according to claim 17, wherein the charging unit controls the potential difference provided between the developer carrier and the image carrier in accordance with the image density detected by the sensor.
